(19) United States
(12) Patent Application Publication
(10) Pub. No.: US 2026/0080370 A1
(43) Pub. Date: Mar. 19, 2026

(54) PREDICTIVE SUBLET MANAGEMENT SYSTEMS AND METHODS

(71) Applicant: Mitchell International, Inc., San Diego, CA (US)

(72) Inventors: Alex Landau, San Diego, CA (US); John Joseph Rozint, San Diego, CA (US); Anurag Jain, San Diego, CA (US); Mitul Shah, San Diego, CA (US)

(21) Appl. No.: 18/887,884

(22) Filed: Sep. 17, 2024

(51) Int. Cl. G06Q 10/20

(52) U.S. Cl. CPC G06Q 10/20

(57) ABSTRACT

Embodiments of the disclosure provide systems and methods for predictive sublet service management based on an automotive repair estimate. According to one embodiment, a method for managing one or more third-party service providers can comprise receiving an estimate for repair of damage to a vehicle, obtaining a list of recommended third-party service providers related to the repair of the damage to the vehicle based on the estimate, and generating one or more service request lines based on the list of recommended third-party service providers. Each service request line can define a service to be performed in the repair of the damage to the vehicle. A service provider recommendation can be generated for each of the one or more service request lines. The generated one or more service request lines can be provided to a system of the service provider based on the service provider selected for each service request line.

### FIELD OF THE DISCLOSURE

Embodiments of the present disclosure relate generally to methods and systems for managing third-party service providers and more particularly to predictive sublet service management based on an automotive repair estimate.

### BACKGROUND

Modern vehicles have become complex systems that can be difficult to repair when damaged. In some cases, the repairs may include or necessitate work that a given repair facility is not able to complete. In such cases, some of the repairs may be sublet to a third-party repair facility. For example, for a vehicle equipped with modern Advanced Driver-Assistance Systems (ADAS) and involved in a front-end collision, the repairs may include a need to recalibrate a camera and/or other sensors used by the ADAS. Such calibrations are beyond the scope of repairs possible at many body shops because of the need for highly specialized equipment and training. Accordingly, these calibrations are commonly sublet to specialized service providers.

Currently, estimators rely on a manual process of choosing which services need to be sublet based on the plan as shown on the repair estimate. With those services identified, the requesting party must then identify a provider that can fulfil such services. These manual processes are prone to errors, scheduling mistakes or oversights, and other deficiencies. Currently, there exists no known way to electronically generate a list of sublet services required to complete a repair and manage those services. Hence, there is a need for improved methods and systems for predictive sublet service management based on an automotive repair estimate.

### BRIEF SUMMARY

Embodiments of the disclosure provide systems and methods for predictive sublet service management based on an automotive repair estimate. According to one embodiment, a method for managing one or more third-party service providers can comprise receiving an estimate for repair of damage to a vehicle by a repair facility, obtaining a list of recommended third-party service providers related to the repair of the damage to the vehicle based on the estimate and in-house capabilities of the repair facility, and generating one or more service request lines based on the list of recommended third-party service providers. Each service request line can define a service to be performed in the repair of the damage to the vehicle. A service provider can be selected for each of the one or more service request lines. The generated one or more service request lines can be provided to a system of the service provider based on the service provider selected for each service request line.

Generating the one or more service request lines can comprise presenting the list of recommended third-party services in a user interface, receiving, through the user interface, a selection of a recommended third-party service from the list of recommended third-party services, and receiving, through the user interface, additional information related to the selected recommended third-party service. The additional information related to the selected recommended third-party service can comprises one or more of an indication of a service to be requested, an indication of a service provider to perform the requested service, a document, a photograph, and/or notes. Generating the one or more service request lines for the selected recommended third-party service can be based on the received additional information. The generated one or more service request lines can be presented through the user interface and submitted for selection of a service provider upon approval of the generated one or more service request lines.

Selecting the service provider for each of the one or more service request lines can comprise reading a service request line of the one or more service request lines and identifying a set of requirements for the services to be performed in the repair of the damage to the vehicle for the service request line. Identifying the set of requirements for the services to be performed in the repair of the damage to the vehicle for the service request line can be based on a set of vehicle repair information for the vehicle. A set of service provider information for each service provider of a plurality of service providers can be read. The set of service provider information for each service provider can comprise one or more of equipment used by the service provider, services offered by the service provider, certifications of the service provider, availability of the service provider, customer satisfaction for the service provider, and/or historical information for the service provider. At least one service provider can be selected from the plurality of service providers based on the identified set of requirements for the services to be performed in the repair of the damage to the vehicle for the service request line and the set of service provider information for each service provider. The selected at least one service provider can be provided as the service provider selected for the service request line. In some cases, selecting at least one service provider from the plurality of service providers can comprise selecting a plurality of service providers and providing the selected at plurality of service providers as the service provider selected for the service request line can comprise providing an ordered list of the plurality of service providers.

According to another embodiment, a system can comprise a processor and a memory coupled with and readable by the processor. The memory can store therein a set of instructions which, when executed by the processor, causes the processor to receive an estimate for repair of damage to a vehicle by a repair facility, obtain a list of recommended third-party service providers related to the repair of the damage to the vehicle based on the estimate and in-house capabilities of the repair facility, and generate one or more service request lines based on the list of recommended third-party service providers. Each service request line can define a service to be performed in the repair of the damage to the vehicle. The instructions can further cause the processor to select a service provider for each of the one or more service request lines and provide the generated one or more service request lines to a system of the service provider based on the service provider selected for each service request line.

According to yet another embodiment, a non-transitory, computer-readable medium can comprise a set of instructions stored therein which, when executed by a processor, causes the processor to receive an estimate for repair of damage to a vehicle by a repair facility, obtain a list of recommended third-party service providers related to the repair of the damage to the vehicle based on the estimate and in-house capabilities of the repair facility, and generate one or more service request lines based on the list of recommended third-party service providers. Each service request line can define a service to be performed in the repair of the damage to the vehicle. The instructions can further cause the processor to select a service provider for each of the one or more service request lines and provide the generated one or more service request lines to a system of the service provider based on the service provider selected for each service request line.

### BRIEF DESCRIPTION OF THE DRAWINGS

FIG. 1 is a block diagram illustrating elements of an exemplary computing environment in which embodiments of the present disclosure may be implemented.

FIG. 2 is a block diagram illustrating elements of an exemplary computing device in which embodiments of the present disclosure may be implemented.

FIG. 3 is a block diagram illustrating elements of an exemplary environment in which predictive sublet management can be performed according to one embodiment of the present disclosure.

FIG. 4 is a flowchart illustrating an exemplary process for managing sublet services according to one embodiment of the present disclosure.

FIG. 5 is a flowchart illustrating additional details of an exemplary process for generating service request lines according to one embodiment of the present disclosure.

FIG. 6 is a flowchart illustrating additional details of an exemplary process for selecting a service provider according to one embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,”“including,”and “having”can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed.

Human input that consents to the performance of the process or operation is not deemed to be “material.” The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S. C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

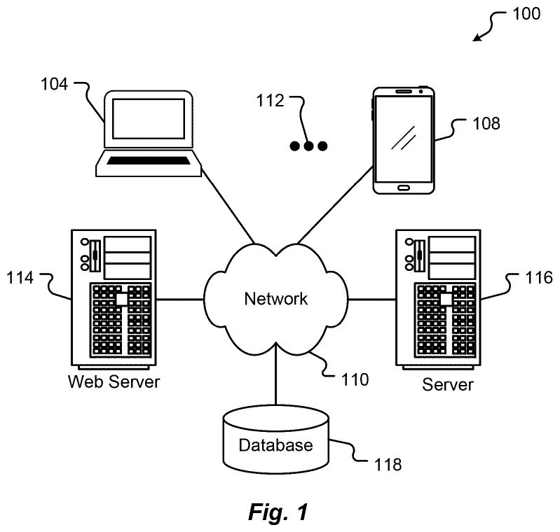

FIG. 1 is a block diagram illustrating elements of an exemplary computing environment in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a communication device 108, and/or more 112. The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. In this example, server 114 is shown as a web server and server 116 is shown as an application server. The web server 114, which may be used to process requests for web pages or other electronic documents from computing devices 104, 108, 112. The web server 114 can be running an operating system including any of those discussed above, as well as any commercially-available server operating systems. The web server 114 can also run a variety of server applications, including SIP servers, HyperText Transfer Protocol (secure) (HTTP(s)) servers, FTP servers, CGI servers, database servers, Java servers, and the like. In some instances, the web server 114 may publish operations available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java™, C, C#®, or C++, and/or any scripting language, such as Perl, Python, or Tool Command Language (TCL), as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for ease of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116. Alternatively, it may be remote from any or all of the computers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as Oracle 20i®, that is adapted to store, update, and retrieve data in response to Structured Query Language (SQL) formatted commands.

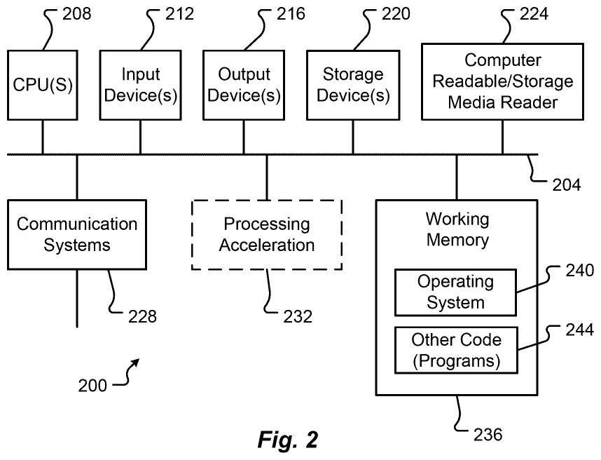

FIG. 2 is a block diagram illustrating elements of an exemplary computing device in which embodiments of the present disclosure may be implemented. More specifically, this example illustrates one embodiment of a computer system 200 upon which the servers, user computers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

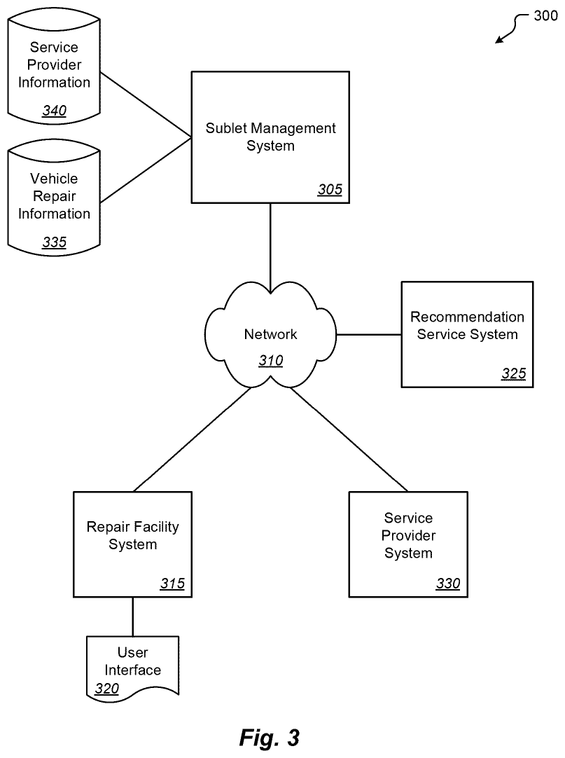

FIG. 3 is a block diagram illustrating elements of an exemplary environment in which predictive sublet management can be performed according to one embodiment of the present disclosure. As illustrated in this example, the environment 300 can comprise a sublet management system 305. The sublet management system 305 can comprise any one or more servers and/or other computing devices as described above. It should be noted that the sublet management system 305 can be part of or associated with other systems providing a broader range of services and set of functions that described herein. For example, the sublet management system 305 can be part of a set of systems (not shown here)
performing an array of automotive collision claims management and repair processes.

The sublet management system 305 can be coupled with a communication network 310. The communication network 310 can comprise any one or more wired and/or wireless, local-area and/or wide-area networks as described above and as known in the art including, but not limited to, the Internet. Also coupled with the communication network 310 can be any number of repair facility systems 315. Generally speaking, the repair facility system 315 can be any one or more computing devices as described above disposed in or accessible at, for example, an automotive body shop or other repair facility.

According to one embodiment, the sublet management system 305, or other systems (not shown here) associated therewith, can provide a user interface 320. This user interface 320 can comprise, for example, a set of web pages or other graphical and/or textual interfaces rendered on a display device of the repair facility system 315. Through such a user interface 315, personnel of the repair facility can submit or generate estimates for repairs, e.g., to repair an automobile or other vehicle damaged in a collision. In some cases, the repairs may include or necessitate work that the repair facility is not able to complete. In such cases, some of the repairs may be sublet to a third-party repair facility. For example, for a vehicle equipped with modern Advanced Driver-Assistance Systems (ADAS) and involved in a front-end collusion, the repairs may include a need to recalibrate a camera and/or other sensors used by the ADAS. Such calibrations are typically performed by a third-party.

According to one embodiment, the sublet management system 305 can manage repairs, such as ADAS calibrations, for example, sublet to third parties by repair facilities for procedures that cannot be performed by the repair facility themselves. Accordingly, the sublet management system 305 can receive an estimate for repair of damage to a vehicle. For example, receiving the estimate can comprise receiving the estimate through a user interface 315 or receiving photographs and descriptions of the damage to the vehicle, e.g., through the user interface 315, and generating the estimate. In either case, the sublet management system 305 can use the estimate to identify services, e.g., ADAS calibration services, that may be needed as part of the repairs.

Stated another way, the sublet management system 305 can obtain a list of recommended third-party service providers related to the repair of the damage to the vehicle based on the estimate. Obtaining the list of recommended third-party service providers related to the repair of the damage to the vehicle can comprise submitting the received estimate to a cloud-based recommendation service system 325 and receiving the list of recommended third-party service providers in response. Information in the estimate or submitted therewith used by the recommendation service system 325 can include, but is not limited to, individual estimate lines, a Vehicle Identification Number (VIN), scan information from a scan tool, etc. In other cases, the sublet management system 305 can obtain the list of recommended third-party service providers related to the repair of the damage to the vehicle by generating the list based on the estimate and other information as described.

The sublet management system 305 can then generate one or more service request lines based on the list of recommended third-party service providers. Each service request line can define a service to be performed in the repair of the damage to the vehicle. Generating the one or more service request lines can comprise presenting the list of recommended third-party service providers in a user interface 320, receiving, through the user interface 320, a selection of a recommended third-party service provider from the list of recommended third-party service providers, and receiving, through the user interface 320, additional information related to the selected recommended third-party service provider. The additional information related to the selected recommended third-party service provider can comprises one or more of an indication of a service to be requested, an indication of a service provider to perform the requested service, a document, a photograph, notes, and/or other information.

The sublet management system 305 can then generate one or more service request lines the selected recommended third-party service provider based on the received additional information. The generated one or more service request lines can be presented through the user interface 320 for review, modification, and approval. Upon approval of the generated one or more service request lines, the service request lines can be submitted for selection of a service provider.

The sublet management system 305 can then select a service provider for each of the one or more service request lines. In some cases, the generated one or more service request lines can then be provided to a system 330 of the service provider based on the service provider selected for each service request line. The sublet management system 305 can select the service provider for each of the one or more service request lines by reading a service request line of the one or more service request lines and identifying a set of requirements for the services to be performed in the repair of the damage to the vehicle for the service request line. Identifying the set of requirements for the services to be performed in the repair of the damage to the vehicle for the service request line can be based on a set of vehicle repair information 335 for the vehicle. This information can include manufacture provided information related to repairs, calibrations, etc. for the vehicle.

The sublet management system 305 can also read a set of service provider information 340 for each service provider. The set of service provider information for each service provider can include, but is not limited to, one or more of equipment used by the service provider, services offered by the service provider, certifications of the service provider, services offered by the service provider, availability of the service provider, customer satisfaction for the service provider, and/or historical information for the service provider. The sublet management system 305 can then select at least one service provider based on the identified set of requirements for the services to be performed in the repair of the damage to the vehicle for the service request line and the set of service provider information 340. The selected at least one service provider can be provided as the service provider selected for the service request line.

The sublet management system 305 can also read a set of information for the repair facility themselves. The set of repair facility information can include, but is not limited to, one or more of equipment used by the repair facility, services offered by the service provider, certifications of the repair facility, services offered by the repair facility, availability of the repair facility, and/or historical information for the repair facility. The sublet management system 305 can then select the repair facility themselves based on the identified set of requirements for the services to be performed in the repair of the damage to the vehicle for the service request line and the set of service provider information 340. The selected service request line, for which the service will be performed in-house by the repair facility themselves, will not be sublet to other service providers.

In some cases, selecting at least one service provider from the plurality of service providers can comprise selecting a plurality of service providers and providing the selected at plurality of service providers as the service provider selected for the service request line can comprise providing an ordered list of the plurality of service providers. For example, the list may be ordered based on a selected factor such as on-time completion rate or customer satisfaction rating for the service providers. In other cases, the list may be ordered based on a combination of factors. In such cases, the various factors may be weighted based on relative importance of such factors. Other variations are contemplated and considered to be within the scope of the present disclosure.

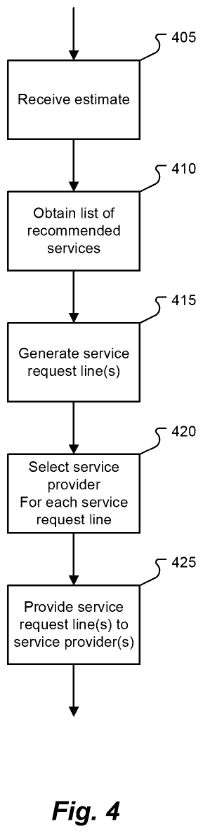

FIG. 4 is a flowchart illustrating an exemplary process for managing sublet services according to one embodiment of the present disclosure. As illustrated in this example, managing one or more third-party service providers can comprise receiving 405 an estimate for repair of damage to a vehicle by a repair facility. Receiving 405 the estimate can be accomplished in a variety of ways as known in the art including, but not limited to, use of a cloud-based service through which estimates can be received, generating the estimate from photographs of the damage to the vehicle, and/or others.

A list of recommended third-party service providers related to the repair of the damage to the vehicle can be obtained 410 based on the estimate and in-house capabilities of the repair facility. As described above, obtaining 410 the list of recommended third-party service providers related to the repair of the damage to the vehicle can comprise submitting the received 405 estimate to a cloud-based service and receiving the list based on the estimate in response. In other cases, obtaining 410 the list of recommended third-party service providers related to the repair of the damage to the vehicle can comprise generating the list based on the estimate and other information as described above.

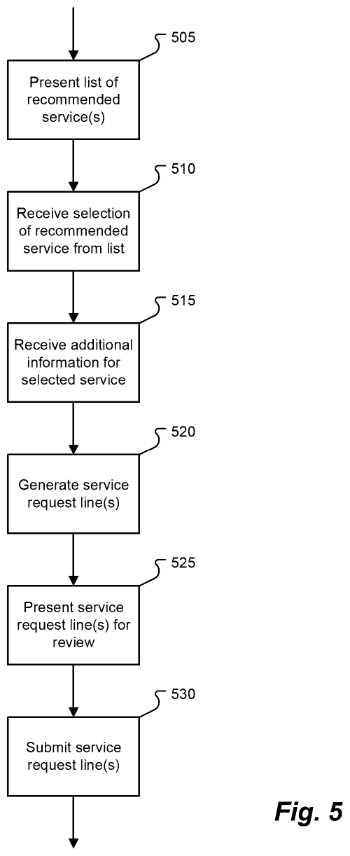

One or more service request lines can be generated 415 based on the list of recommended third-party service providers. Each service request line can define a service to be performed in the repair of the damage to the vehicle. Generally speaking, generating 415 each service request line can comprise collecting, e.g., through a user interface, additional information related to the service request line. Additional details of an exemplary process for generating 415 a service request line will be described below with reference to FIG. 5.

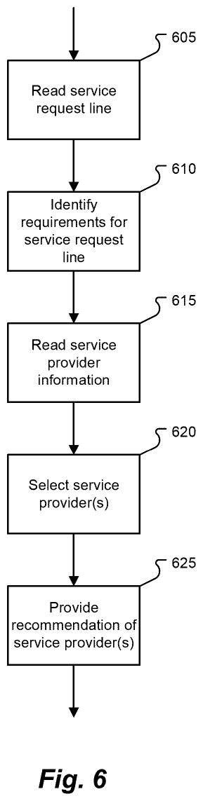

A service provider can be selected 420 for each of the one or more service request lines. In some cases, the selected 420 one or more service request lines can then be provided 425 to a system of the service provider based on the service provider selected for each service request line. Generally speaking, selecting 420 the service provider can be based on the service request line and a set of information regarding each of the service providers and where the recommendation is based on a match between the requirements of the service request line and the information about each service provider. Additional details of an exemplary process for selecting 420 a service provider will be described below with reference to FIG. 6.

FIG. 5 is a flowchart illustrating additional details of an exemplary process for generating service request lines according to one embodiment of the present disclosure. As illustrated in this example, generating the one or more service request lines can comprise presenting 505 the list of recommended third-party service providers in a user interface, receiving 510, through the user interface, a selection of a recommended third-party service provider from the list of recommended third-party service providers, and receiving 515, through the user interface, additional information related to the selected recommended third-party service provider. The additional information related to the selected recommended third-party service provider can comprises one or more of an indication of a service to be requested, an indication of a service provider to perform the requested service, a document, a photograph, notes, and/or other information.

The one or more service request lines can then be generated 520 for the selected recommended third-party service provider based on the received additional information. The generated one or more service request lines can be presented 525 through the user interface for review, modification, and approval. Upon approval of the generated one or more service request lines, the service request lines can be submitted 530 for selection of a service provider.

FIG. 6 is a flowchart illustrating additional details of an exemplary process for selecting a service provider according to one embodiment of the present disclosure. As illustrated in this example, selecting the service provider for each of the one or more service request lines can comprise reading 605 a service request line of the one or more service request lines and identifying 610 a set of requirements for the services to be performed in the repair of the damage to the vehicle for the service request line. Identifying the set of requirements for the services to be performed in the repair of the damage to the vehicle for the service request line can be based on a set of vehicle repair information for the vehicle.

A set of service provider information for each service provider of a plurality of service providers can be read 615. The set of service provider information for each service provider can comprise one or more of equipment used by the service provider, services offered by the service provider, certifications of the service provider, availability of the service provider, customer satisfaction for the service provider, and/or historical information for the service provider. At least one service provider can be selected 620 from the plurality of service providers based on the identified set of requirements for the services to be performed in the repair of the damage to the vehicle for the service request line and the set of service provider information for each service provider. The selected at least one service provider can be provided 625 as the service provider selected for the service request line. In some cases, selecting 620 at least one service provider from the plurality of service providers can comprise selecting a plurality of service providers and providing 625 the selected at plurality of service providers as the service provider selected for the service request line can comprise providing an ordered list of the plurality of service providers.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A method for managing one or more third-party service providers, the method comprising:
receiving, by a processor of a sublet management system, an estimate for repair of damage to a vehicle by a repair facility;
submitting, by the processor of the sublet management system, the estimate to a system of a recommendation service;
obtaining, by the processor of the sublet management system, from the system of the recommendation service, a list of recommended third-party service providers related to the repair of the damage to the vehicle based on the estimate and in-house capabilities of the repair facility;
generating, by the processor of the sublet management system, one or more service request lines based on the list of recommended third-party service providers, each service request line defining a service to be performed in the repair of the damage to the vehicle;
selecting, by the processor of the sublet management system, a service provider for each of the one or more service request lines; and
providing, by the processor of the sublet management system, the generated one or more service request lines to a system of the service provider based on the service provider selected for each service request line.

2. The method of claim 1, wherein generating the one or more service request lines further comprises:
presenting, by the processor of the sublet management system, the list of recommended third-party service providers in a user interface of the sublet management system;
receiving, by the processor of the sublet management system, through the user interface, a selection of a recommended third-party service provider from the list of recommended third-party service providers;
receiving, by the processor of the sublet management system, through the user interface, additional information related to the selected recommended third-party service provider, wherein generating the one or more service request lines for the selected recommended third-party service provider is based on the received additional information;
presenting, by the processor of the sublet management system, through the user interface, the generated one or more service request lines; and
submitting, by the processor of the sublet management system, the generated one or more service request lines for selection of a service provider upon approval of the generated one or more service request lines.

3. The method of claim 2, wherein the additional information related to the selected recommended third-party service provider comprises one or more of an indication of a service to be requested, an indication of a service provider to perform the requested service, a document, a photograph, or notes.

4. The method of claim 1, wherein selecting the service provider for each of the one or more service request lines further comprises:
reading a service request line of the one or more service request lines;
identifying a set of requirements for the services to be performed in the repair of the damage to the vehicle for the service request line;
reading a set of service provider information for each service provider of a plurality of service providers;
selecting at least one service provider from the plurality of service providers based on the identified set of requirements for the services to be performed in the repair of the damage to the vehicle for the service request line and the set of service provider information for each service provider; and
providing the selected at least one service provider as the service provider selected for the service request line.

5. The method of claim 4, wherein identifying the set of requirements for the services to be performed in the repair of the damage to the vehicle for the service request line is based on a set of vehicle repair information for the vehicle.

6. The method of claim 4, wherein the set of service provider information for each service provider comprises one or more of equipment used by the service provider, services offered by the service provider, certifications of the service provider, availability of the service provider, customer satisfaction for the service provider, or historical information for the service provider.

7. The method of claim 4, wherein selecting at least one service provider from the plurality of service providers comprises selecting a plurality of service providers and wherein providing the selected at plurality of service providers as the service provider selected for the service request line comprises providing an ordered list of the plurality of service providers.

8. A system comprising:
a processor; and
a memory coupled with and readable by the processor and storing therein a set of instructions which, when executed by the processor, causes the processor to:
receive an estimate for repair of damage to a vehicle by a repair facility;
submit the estimate to a system of a recommendation service;
obtain, from the system of the recommendation service, a list of recommended third-party service providers related to the repair of the damage to the vehicle based on the estimate and in-house capabilities of the repair facility;
generate one or more service request lines based on the list of recommended third-party service providers, each service request line defining a service to be performed in the repair of the damage to the vehicle;
select a service provider for each of the one or more service request lines; and
provide the generated one or more service request lines to a system of the service provider based on the service provider selected for each service request line.

9. The system of claim 8, wherein generating the one or more service request lines further comprises:
presenting the list of recommended third-party service providers in a user interface of the sublet management system;
receiving through the user interface, a selection of a recommended third-party service provider from the list of recommended third-party service providers;
receiving through the user interface, additional information related to the selected recommended third-party service provider, wherein generating the one or more service request lines for the selected recommended third-party service provider is based on the received additional information;
presenting, through the user interface, the generated one or more service request lines; and
submitting the generated one or more service request lines for selection of a service provider upon approval of the generated one or more service request lines.

10. The system of claim 9, wherein the additional information related to the selected recommended third-party service provider comprises one or more of an indication of a service to be requested, an indication of a service provider to perform the requested service, a document, a photograph, or notes.

11. The system of claim 8, wherein selecting the service provider for each of the one or more service request lines further comprises:
reading a service request line of the one or more service request lines;
identifying a set of requirements for the services to be performed in the repair of the damage to the vehicle for the service request line;
reading a set of service provider information for each service provider of a plurality of service providers;
selecting at least one service provider from the plurality of service providers based on the identified set of requirements for the services to be performed in the repair of the damage to the vehicle for the service request line and the set of service provider information for each service provider; and
providing the selected at least one service provider as the service provider selected for the service request line.

12. The system of claim 11, wherein identifying the set of requirements for the services to be performed in the repair of the damage to the vehicle for the service request line is based on a set of vehicle repair information for the vehicle.

13. The system of claim 11, wherein the set of service provider information for each service provider comprises one or more of equipment used by the service provider, services offered by the service provider, certifications of the service provider, availability of the service provider, customer satisfaction for the service provider, or historical information for the service provider.

14. The system of claim 11, wherein selecting at least one service provider from the plurality of service providers comprises selecting a plurality of service providers and wherein providing the selected at plurality of service providers as the service provider selected for the service request line comprises providing an ordered list of the plurality of service providers.

15. A non-transitory, computer-readable medium comprising a set of instructions stored therein which, when executed by a processor, causes the processor to:
receive an estimate for repair of damage to a vehicle by a repair facility;
submit the estimate to a system of a recommendation service;
obtain, from the system of the recommendation service, a list of recommended third-party service providers related to the repair of the damage to the vehicle based on the estimate and in-house capabilities of the repair facility;
generate one or more service request lines based on the list of recommended third-party service providers, each service request line defining a service to be performed in the repair of the damage to the vehicle;
select a service provider for each of the one or more service request lines; and
provide the generated one or more service request lines to a system of the service provider based on the service provider selected for each service request line.

16. The non-transitory, computer-readable medium of claim 15, wherein generating the one or more service request lines further comprises:
presenting, by the processor of the sublet management system, the list of recommended third-party service providers in a user interface of the sublet management system;
receiving, by the processor of the sublet management system, through the user interface, a selection of a recommended third-party service provider from the list of recommended third-party service providers;
receiving, by the processor of the sublet management system, through the user interface, additional information related to the selected recommended third-party service provider, wherein generating the one or more service request lines for the selected recommended third-party service provider is based on the received additional information;
presenting, by the processor of the sublet management system, through the user interface, the generated one or more service request lines; and
submitting, by the processor of the sublet management system, the generated one or more service request lines for selection of a service provider upon approval of the generated one or more service request lines.

17. The non-transitory, computer-readable medium of claim 16, wherein the additional information related to the selected recommended third-party service provider comprises one or more of an indication of a service to be requested, an indication of a service provider to perform the requested service, a document, a photograph, or notes.

18. The non-transitory, computer-readable medium of claim 15, wherein selecting the service provider for each of the one or more service request lines further comprises:
reading a service request line of the one or more service request lines;
identifying a set of requirements for the services to be performed in the repair of the damage to the vehicle for the service request line;
reading a set of service provider information for each service provider of a plurality of service providers;
selecting at least one service provider from the plurality of service providers based on the identified set of requirements for the services to be performed in the repair of the damage to the vehicle for the service request line and the set of service provider information for each service provider; and
providing the selected at least one service provider as the service provider selected for the service request line.

19. The non-transitory, computer-readable medium of claim 18, wherein identifying the set of requirements for the services to be performed in the repair of the damage to the vehicle for the service request line is based on a set of vehicle repair information for the vehicle.

20. The non-transitory, computer-readable medium of claim 18, wherein the set of service provider information for each service provider comprises one or more of equipment used by the service provider, services offered by the service provider, certifications of the service provider, availability of the service provider, customer satisfaction for the service provider, or historical information for the service provider.
